(19) United States
(12) Patent Application Publication
(10) Pub. No.: US 2014/0143712 A1
(43) Pub. Date: May 22, 2014

(54) DISPLAY APPARATUS HAVING TOUCH SCREEN AND SCREEN CONTROL METHOD THEREOF

(71) Applicant: Industry-University Cooperation Foundation Sunmoon University, Asan-si (KR)

(72) Inventor: In Hyun Nahm, Asan-si (KR)

(73) Assignee: Industry-University Cooperation Foundation Sunmoon University, Asan-si (KR)

(21) Appl. No.: 13/900,453

(22) Filed: May 22, 2013

(30) Foreign Application Priority Data
Nov. 16, 2012 (KR) 10-2012-0130485

(51) Int. Cl. G06F 3/0485

(52) U.S. Cl. CPC G06F 3/0485
USPC 715/784

(57) ABSTRACT

The display apparatus includes: a touch input sensing unit that senses a touch type, a touch position, and a touch time by a user touch input in a work command area formed in a band type along each side of the touch screen; a work type selecting unit that selects scroll of an image displayed on the touch screen as a work type when the touch type is a single touch, and selects rotation of the image or scaling of the image by the touch position when the touch type is a dual touch, based on the touch type, the touch position, and the touch time sensed from the touch input sensing unit; and a work executing unit that executes any one work of the scroll, rotation, and scaling of the image based on the work type selected from the work type selecting unit.

### CROSS-REFERENCE TO RELATED APPLICATION

This application claims priority to Korean Patent Application No. 10-2012-0130485, filed on Nov. 16, 2012, and all the benefits accruing therefrom under 35 U.S.C. §119, the contents of which in its entirety are herein incorporated by reference.

### BACKGROUND

1. Field of the Invention

The present disclosure is as to a display apparatus and a screen control method thereof, and more particularly as to a display apparatus having a touch screen and a screen control method thereof.

2. Description of the Related Art

According to the explosive growth of mobile device market, the use of display apparatus having touch screen, such as Tablet PC (Personal Computer) and smart phone, has been widespread.

Generally, in using the touch screen, the user inputs a command by pressing or dragging the screen with one or two fingers. Since people have used for a long time the pressing operation in using the apparatus like typewriter and PC, there are no particular problems in that operation. In contrast, the dragging operation has not been widely used except by the workers in the specialized field, and thus it is expected that large or small problems would be caused sooner or later by the excessive use of such handlings on the occasion of mobile age.

Specifically the operation of dragging the touch screen with a fingertip could cause the following undesirable side effects.

Firstly, the fingerprints could be damaged.

Secondly, because the fingertip is restricted on the 2-dimensional plane of the touch screen, large load is applied to finger and carpal joints, and ligaments thereof could be damaged in a variety of ways.

It is expected that such phenomenon would be more serious particularly in a small size apparatus less than 11 inches. This is because people scarcely move their elbow while handling the small size apparatus less than 11 inches.

Recently, the cases that cervical vertebra of neck is damaged by the excessive use of smart phone and thus limbs are partially paralyzed, have been reported through media. This suggests that a serious result could be caused by the habits of user.

### RELATED LITERATURES

### Patent Literature

Korean Patent No. 10-1182076

### SUMMARY

The present disclosure is proposed to solve the problems of the related art as described above, and is to provide a display apparatus having a touch screen and a screen control method thereof, capable of performing a screen control which a user desires, only by pressing operation in which the dragging operation, used in the touch screen concerned, and expected to have side effects, is replaced by pressing operation, thereby reducing the load applied to the user to make a digital life of moderns healthy.

The technical aspects of the present disclosure are not limited to the technical problem mentioned above, and persons skilled in the field should be able to understand clearly other non-mentioned technical problems from the following description.

In this scheme the display apparatus having touch screen includes; a touch input sensing unit that senses a touch type, such as touch position and touch time, by the occurrence of a touch in the command area, formed in a band type along each side of the touch screen; a work type selecting unit that selects the screen scrolling along the horizontal, vertical or diagonal direction in the case of single touch, and selects rotation or scaling of the screen image in the case of a dual touch, on the basis of the touch type, such as the touch position and the touch time, sensed from the touch input sensing unit; and a work executing unit that executes the screen scrolling, rotation, or scaling of the screen image, on the basis of the work type selected from the work type selecting unit.

The work command area of each sides consists of plural divisional spots including a central spot and two neighbor spots consecutive to the central spot, on the left and the right from the central spot in the case of upper or lower side, and on the upper and lower from the central spot in the case of left and right side, and four spots located at the four corners of the screen.

These spots may be invisible in ordinary occasion but may appear when the user touches the work command area.

The work type selecting unit sets the scrolling direction and distance of the screen on the basis of the touch position and time when the touch type is a single touch, and the work executing unit scrolls the screen by the set scroll direction and distance.

When the scrolling direction of the screen is set by the command area touched by the user, the work executing unit scrolls, either x/n of the screen in the set scrolling direction when the touch time is shorter than a preset time, usually between 0.3 and 0.5 second, or the whole screen in the set scrolling direction when the touch time is longer than the preset time, where n is a natural number, and x may be, either the vertical length of the screen when the set scrolling direction is vertical, or the horizontal length of the screen when the set scrolling direction is horizontal, or the diagonal length of the screen when the set scrolling direction is diagonal.

The work type selecting unit sets the rotation direction (clockwise or counterclockwise) and angle of the screen on the basis of the touch position and time when the two command spots, including mandatorily the mid spot of the plural command spots at each side, are dual-touched, i.e. touched simultaneously, and the work executing unit rotates the screen by the set rotation direction and angle.

The work type selecting unit sets the rotation direction that is clockwise or anticlockwise on the basis of the direction directed from the middle spot to the other neighbor touched command spot, when touches simultaneously occur in the two touched command spots, by the rotation angle smaller than 90° in proportion to the touch time. When touches sequentially occur in the two touched command spots, the work type selecting unit could set the rotation angle to 90°.

The rotation center could be set to, either the center of the touch screen, or the midpoint of the side facing the side touched by the user, or the corner point of the touch screen. When the corner point is chosen to be the rotation center, the furthermost corner point from the two touched command spots would be selected.

When a pair of command spots, facing each other on the touch screen, are simultaneously touched (dual-touch), the work type selecting unit could set enlargement or reduction, depending on the ratio based on the touch position and time.

The distance between a pair of command spots facing each other is defined to be the distance between left and right command spots facing each other, i.e. the horizontal length of the screen, or the distance between upper and lower command spots facing each other, i.e. the vertical length of the screen. The image could be enlarged when the distance between a pair of command spots, located on the opposite sides each other and touched simultaneously (dual touch), is longer than the other way around, and the image could be reduced when the distance between a pair of command spots, located on the opposite sides each other and touched simultaneously (dual touch), is shorter than the other way around. The image could be enlarged more than once and less than twice as much, when the touch time is shorter than the preset time, and the image could be enlarged equal to or more than twice as much, when the touch time is longer than the preset time, usually between 0.3 and 0.5 second. The reduction ratio could be set to the reciprocal number of the enlargement ratio.

On the other hand, there is provided a screen control method of the display apparatus having touch screen including: sensing the touch type, the touch position, and the touch time by occurrence of touch in the work command spot, formed on each side of the touch screen, and comprising the plural command spots; selecting the type of scroll of the image displayed on the touch screen when the touch type is a single touch, and selecting the type of rotation of the image, or the type of scaling of the image by the touch position in the case of a dual touch, on the basis of the sensed touch type, touch position, and touch time; and executing any of the scroll, the rotation, and the scaling of the image on the basis of the selected work type.

The selecting of the work type could include: setting a scroll direction and distance of the image for scroll on the basis of the touch position and time in the case of a single touch; selecting the rotation of the image as the work type, by rotation direction and angle on the basis of the positions of the two touched spots and touch time in the case of a dual touch, from the two spots including mandatorily the mid spot among the plural command spots in the work command area; and selecting the scaling of the image as the work type, setting enlargement or reduction, with the enlargement or reduction ratio of the image on the basis of the touch position and time in the case of dual touch, for a pair of command spots facing each other in the touch screen.

In compliance with the display apparatus having touch screen and the screen control method thereof disclosed herein, it is possible to perform the screen control desired by the user, only by pressing operation, and thus the dragging operation used in the touch screen concerned and expected to have side effects, is replaced by the pressing operation, thereby reducing load applied to the user to make a digital life of modern people healthy.

### BRIEF DESCRIPTION OF THE DRAWINGS

The above and other features, and advantages of the disclosed embodiments will be more apparent from the following detailed description taken in conjunction with the accompanying drawings in which:

FIG. 1 is a schematic diagram illustrating the configuration of display apparatus having touch screen by the embodiment of the present disclosure;

FIGS. 2A and 2B are diagrams illustrating the configuration of touch screen by the embodiment of the present disclosure;

FIGS. 3A and 3B are diagrams illustrating the configuration of touch screen by another embodiment of the present disclosure;

FIG. 4 is a diagram exemplarily illustrating the scroll operation of the image of display apparatus having touch screen by the embodiment of the present disclosure;

FIG. 5A, 5B and FIG. 6 are diagrams exemplarily illustrating the rotation operation of the image of display apparatus having touch screen by the embodiment of the present disclosure;

FIG. 7 is a diagram exemplarily illustrating the scaling operation of the image of display apparatus having touch screen by the embodiment of the present disclosure; and

FIG. 8 is the flowchart illustrating the screen control method of display apparatus having touch screen by the embodiment of the present disclosure.

### DETAILED DESCRIPTION OF MAIN ELEMENTS

110: TOUCH INPUT SENSING UNIT
120: WORK TYPE SELECTING UNIT
130: WORK EXECUTING UNIT

### DETAILED DESCRIPTION

As an example of the screen control operation in using touch screen, first there is a movement of scrolling the screen in the horizontal direction or the vertical direction in the text mode such as in the menu screen.

Further, the movement in the diagonal direction, rotation, enlargement (e.g. zoom-in), and reduction (e.g. zoom-out) are added in the graphic mode such as map or picture in addition to scrolling the screen in the horizontal and vertical directions.

In the mobile apparatus of the conventional scheme, the dragging operation is mandatory for all commands for scrolling, rotation, enlargement, and reduction. For example, the scrolling of an image displayed on the touch screen is executed by pressing and dragging the screen with one finger, and the enlargement and the reduction are executed by pressing and dragging the screen with two fingers through multi-touch.

On the contrary, in the embodiment of the present disclosure, the dragging operation can be avoided in all the screen control methods, such as scroll, rotation, enlargement and reduction, and the dragging operation is replaced by a single or double press using one or two fingers.

Hereinafter, the display apparatus having touch screen and the screen control method in compliance with the preferred embodiment of the present disclosure will be described in detail with reference to the accompanying drawings.

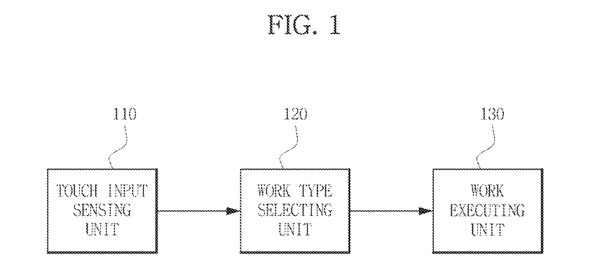

FIG. 1 is a schematic diagram illustrating the configuration of the display apparatus having touch screen in accordance with the embodiment of the present disclosure.

Referring to FIG. 1, the display apparatus having touch screen in compliance with the embodiment of the present disclosure comprises the touch input sensing unit 110, the work type selecting unit 120, and the work executing unit 130.

The touch input sensing unit 110 senses the touch type, the touch position and touch time, when the user touches the command area of the screen, which has the shape of a band along four each side (left, right, upper and lower side) of the touch screen.

The work command area is defined to be the area of band shape along each side of the touch screen, and each side of the work command area includes plural command spots performing different operation.

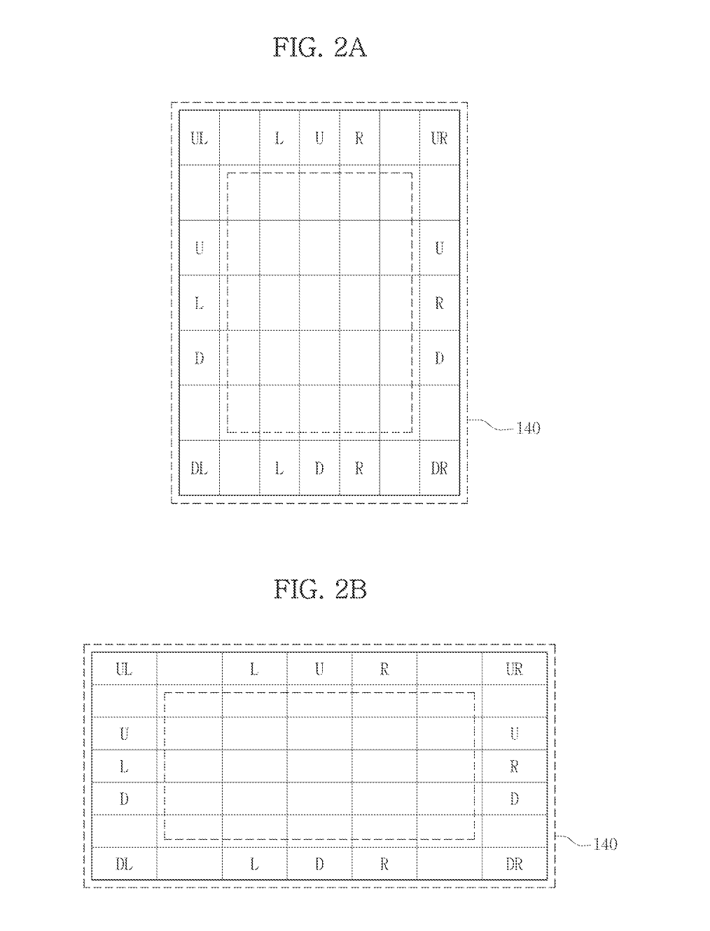

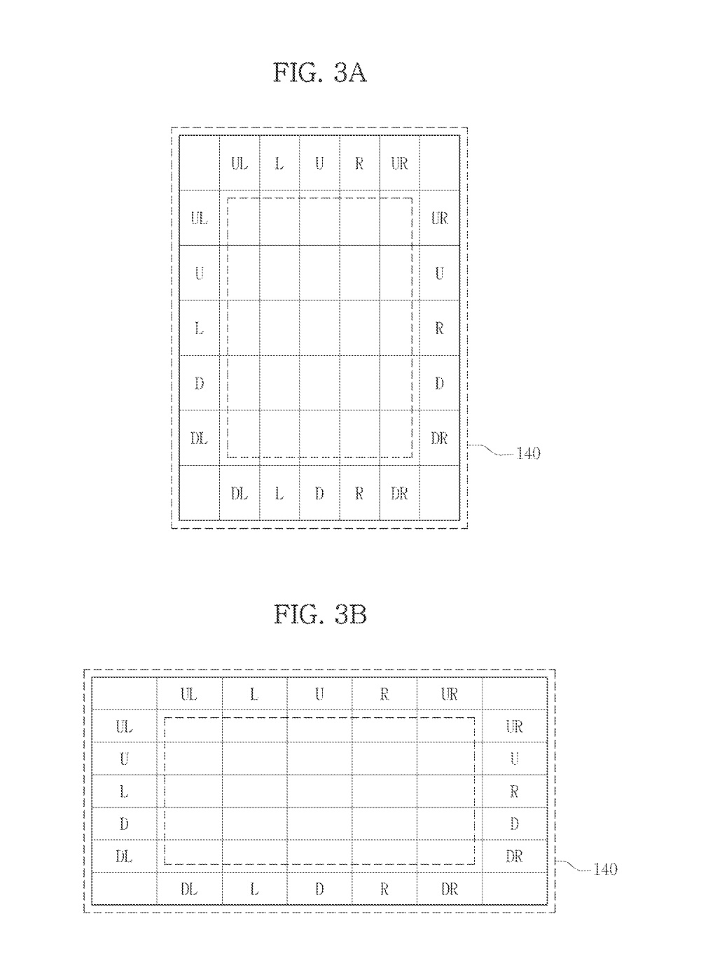

The deployment of command spots in each side of the work command area 140 is exemplarily illustrated in FIG. 2 and FIG. 3.

The work type selecting unit 120 selects any of the work types, namely scrolling, rotation, and scaling of the image displayed on the touch screen, on the basis of the touch type, the touch position and time, sensed by the touch input sensing unit 110. Specifically, the work type selecting unit 120 selects the scrolling of the image as the work type in the case of a single touch, and selects rotation or scaling of the image as the work type according to the touch position (the positions of two touches) in the case of a dual touch. The scaling of the image means enlargement or reduction of the image displayed on the touch screen. In this embodiment the image includes still image such as photograph or text, and moving image.

The work executing unit 130 executes one of the scrolling, rotation, and scaling of the image on the basis of the work type selected by the work type selecting unit 120.

FIGS. 2A and 2B are diagrams illustrating the embodiment of the configuration of touch screen by the present disclosure, and FIGS. 3A and 3B are diagrams illustrating the embodiment of the configuration of the touch screen by another embodiment of the present disclosure.

In FIGS. 2A & 2B and FIGS. 3A & 3B, each term L, R, U, D, UL, UR, DL, DR of the command spots in the work command area 140 means left (L), right (R), up (U), down (D), up-left (UL), up-right (UR), down-left (DL), and down-right (DR), in sequence respectively.

In addition, FIG. 2A and FIG. 3A illustrate the portrait mode, and FIG. 2B and FIG. 3B illustrate the landscape mode.

In the embodiment as shown in FIGS. 2A and 2B, a work command area 140 is chosen to take the band shape along each side of the screen. The work command area 140 is divided into plural command spots, where each has a size to the extent that a fingerprint is printed with a fingertip centering on the center of each spot.

Each side of the work command area 140 includes plural command spots, where there are three command spots around the midpoint of the each side and four additional command spots located at the four corners of the screen.

For example, the right side of the work command area 140 consists of the mid spot R, two neighbor spots, U and D positioned on the upper and lower of the mid spot R, and two additional spots UR, DR positioned on the both edges of the right side.

The shape of each command spot could be chosen to be a circle, an ellipse, or a rectangle with a predetermined diameter or diagonal length (for example, 1.5 cm). Furthermore each command spot could be as small as that it is possible to recognize the spot with the naked eyes irrespective of the size (for example, a diameter of 0.5 cm).

In another embodiment, the two diagonal spots (i.e. UR, DR of the right side and UL, DL of the left side) could be placed on both sides adjacent to three command spots in the middle of each side, not on the corners (for example, U, R, D on the right side) in case of middle or large size apparatus such as a tablet PC or larger device screen, or on the corners of the screen in the case of small size apparatus such as smart phone, at the user's convenience.

All these command areas may not be seen in ordinary case, which is the case that the user does not touch the screen, but can be seen when the user touches the work command area 140 for screen control.

The embodiment illustrated in FIGS. 2A and 2B exemplarily shows a small size apparatus such as a smart phone, where overall four diagonal spots UL, UR, DL, DR in the work command area 140 are displayed at the corners of the screen.

Another embodiment illustrated in FIGS. 3A and 3B exemplarily shows the middle or large size apparatus such as a tablet PC or larger device screen of medical or military use, where two diagonal spots (for example, UR, DR of the right side) in each side of the work command area 140 are located on both ends adjacent of three command spots in the middle of each side (for example, U, R, D). For example, the right side of the work command area 140 includes three command spots in the middle (i.e. U, L, D) and two diagonal spots (i.e. UL, DL) which is adjacent to both edges of the three command spots in the middle. Thus, overall 8 diagonal spots (UL, UR of the upper side, UR, DR of the right side, DL, DR of the lower side, and UL, DL of the left side) can be defined on the screen.

The screen control operation of this disclosure owing to the touch type will be described in the following.

Firstly, the scrolling of the image of the touch screen in the horizontal, vertical, and diagonal directions is performed by a single touch using one finger.

Secondly, the scaling of the image, such as enlargement or reduction, is performed by a dual touch using two fingers.

The dual touch is classified into simultaneous touch and sequential touch. The sequential touch could be used for 90° rotation of the screen, and the simultaneous touch could be used for the other kind of rotation depending on the needs, enlargement or reduction of the image.

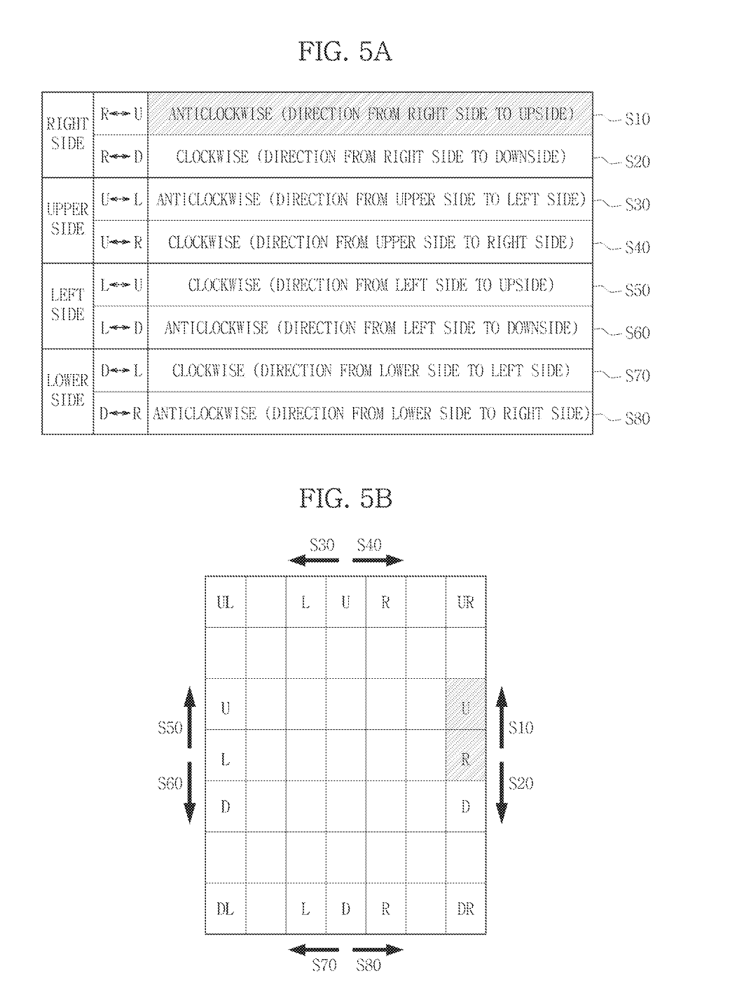

Hereinafter, the screen control operation based on the touch type, the touch position and the touch time, will be described in more detail with reference to FIG. 5 to FIG. 7. In FIG. 5 to FIG. 7, a two-way arrow (←→) indicates the simultaneously touch, and a one-way arrow (→) indicates the sequential touch.

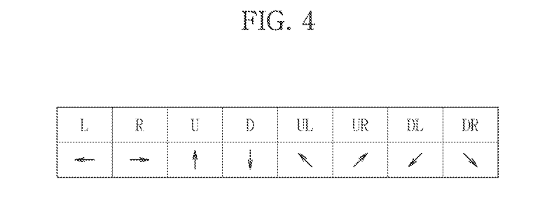

FIG. 4 illustrates the scrolling direction of the image on the display apparatus having touch screen by the embodiment of the present disclosure.

In this embodiment, when the touch type is a single touch, the work type selecting unit 120 selects the scrolling of the image as the work type, and sets the scrolling direction and distance of the image on the basis of the touch position and the touch time, then the work executing unit 130 scrolls the image along the scrolling direction and distance set by.

The work type selecting unit 120 sets the scrolling direction of the image on the basis of the location of the spot in the command area of each side touched by the user. For example, when the user presses L, the image is scrolled to the left direction, and when the user presses UR, the image is scrolled to the upper right diagonal direction.

When the user presses each command spot with a fingertip, the scrolling direction of the image is set to the direction of the arrow as shown in the table of FIG. 4. For example, when the user touches U in the command spots in the work command area, the work type selecting unit 120 senses the touch, and scrolls the image to the upper side. As described above, in response to the user touch, the image is scrolled in any one direction of left L, right R, up U, down D, up-left UL, up-right UR, down-left DL, and down-right DR.

In this case, the scrolling distance could be set by the touch time.

In this embodiment, the work type selecting unit 120 sets the scrolling distance of the image on the basis of the touch time. When the touch time is shorter than the preset time (usually between 0.3 and 0.5 second), the image is scrolled by x/n of the image (for example, ½ or ⅓) in the set scrolling direction, and when the touch time is longer than the preset time, the image is scrolled by the whole of the image displayed on the touch screen, that is, n/n, in the set scroll direction, where n is a natural number such as 1, 2, 3 and so on.

In this case x is the vertical length of the screen in the case of vertical scroll, such as up and down, or x is a horizontal length of the screen in the case horizontal scroll, such as left and right, and x is a diagonal distance of the screen in the case diagonal scroll. The value of n could be determined by the need of user or manufacturer.

FIGS. 5A & 5B and FIG. 6 are exemplarily illustrating rotation of the image of a display apparatus having touch screen by the embodiment of the present disclosure.

FIGS. 5A and 5B show the example of rotation of the image by an acute angle by the simultaneous touch, and FIG. 6 shows an example of 90° rotation by the sequential touch.

In this embodiment, the rotation of the image needs the dual touch with two fingers. The dual touch includes a simultaneous touch of two spots with two fingers and a sequential touch of two touch spots. In the sequential touch the middle spot is touched first and the other spot is touched next. The rotation direction is from the middle spot to the next spot touched.

When the touch type is a dual touch and the dual-touch spots are two command spots in one side of the work command area, where the two command spots include the mid spot of the one side mandatorily, the work type selecting unit 120 selects the rotation of the image as the work type. Thus, the work type selecting unit 120 sets the rotation direction and angle of the image on the basis of the touch position and time. This directs the work executing unit 130 to rotate the image by the set rotation direction and angle.

The FIG. 5A shows an overall table of the simultaneous touch and the rotation direction, and FIG. 5B shows the actual rotation direction of the simultaneous touch on the screen. In the table of FIG. 5A, the two-way arrow (←→) means the simultaneous touch.

In this embodiment, when the user touches the middle spot (for example, R of the right side) and the other neighbor spot (for example, U of the right side) on the same side simultaneously, the work type selecting unit 120 is said to be operated in the simultaneous touch mode. In this case, the rotation takes the direction from the middle spot (for example, R on the right side) to the other neighbor spot (for example U on the same side).

On the basis of this configuration, the rotation could be performed in any desired direction by the user on any side of the screen.

In rotation of the image, the user could use only two consecutive spots among three spots in any side of the work command area, namely the middle spot of each side (for example, R on the right side) and the other neighbor spot on the same side (for example, U or D on the right side). The command spot on the other side would be assigned a rotation direction in a similar way by this embodiment.

The work type selecting unit 120 selects the direction from the middle spot to the other neighbor spot on the basis of the positions of two touch spots, setting the direction out of the clockwise and anticlockwise directions.

For example, in FIGS. 5A and 5B, when the user touches ‘R←→U’ in the command spots on the right side of the command area, the rotation direction is anticlockwise one defined by S10, directed from the middle spot (R) to the upper spot (U). When the user touches ‘R←→D’, the rotation direction is the clockwise one S20, directed from the middle spot (R) to the lower spot (D).

In this case, the rotation angle could be determined from the touch time and the touch type, out of the simultaneous touch and the sequential touch.

In this embodiment, the work type selecting unit 120 sets the rotation angle to be acute range smaller than 90°, sensing the touch time for the simultaneous touch, and sets the rotation angle to be 90° for the case of sequential touch.

In contrast with the conventional multi-touch scheme, which sets the midpoint between two touch spots as the rotation center, the embodiment of the present disclosure could take any one of the three points as the rotation center, namely the center point of the whole screen, or the midpoint or one of the two endpoints of the side facing the touched one.

When the rotation center is chosen to be an endpoint of the side, the furthermost one from the two touch spots should be selected among the two ends on the side. For example, the rotation center should be the lower left corner point near ‘DL’ when the user touches ‘R←→U’ of the command area on the right side simultaneously or sequentially, and the rotation center should be the upper left corner point near ‘UL’ when the user touches ‘R←→D’ on the side simultaneously or sequentially.

The rotation angle could be set by the touch time in the case of simultaneous touch. For example, when the touch time is shorter than the preset time (for example between 0.3 and 0.5 second), the image is rotated by the first acute angle range (usually between 10° and 30°). When the touch time is longer than the preset time, the image could be rotated by the second acute angle range (usually between 40° and 60°), somewhat larger than the first acute angle range.

In this embodiment, when the user sequentially touches the two command spots on the side of the command area, that is firstly the middle spot on the side (for example, R on the right side) and secondly the neighbor spot (for example, U or D on the right side) on the same side, the work type selecting unit 120 chooses the sequential touch mode.

The operation in the sequential mode should be done more carefully than in the simultaneous mode, and this can be used for 90° rotation of the image.

The displayed image on the screen would be rotated to the direction along the touching sequence. When the user touches the middle spot on one side and sequentially touches the neighbor spot on the same side, the image could be rotated to the direction from the middle spot to the neighbor spot.

The setting of the rotation direction in the sequential touch is exemplarily shown in the table of FIG. 6. In FIG. 6, the one-way arrow (→) means the sequential touch.

In the embodiment illustrated in FIG. 6, the image displayed on the screen could be rotated to any direction desired by the user, on any side of the screen. In the sequential touch mode shown in FIG. 6, the rotation direction and the rotation center could be set in the same way as in the simultaneous touch mode shown in FIGS. 5A and 5B, but the rotation angle is different by the way of pressing.

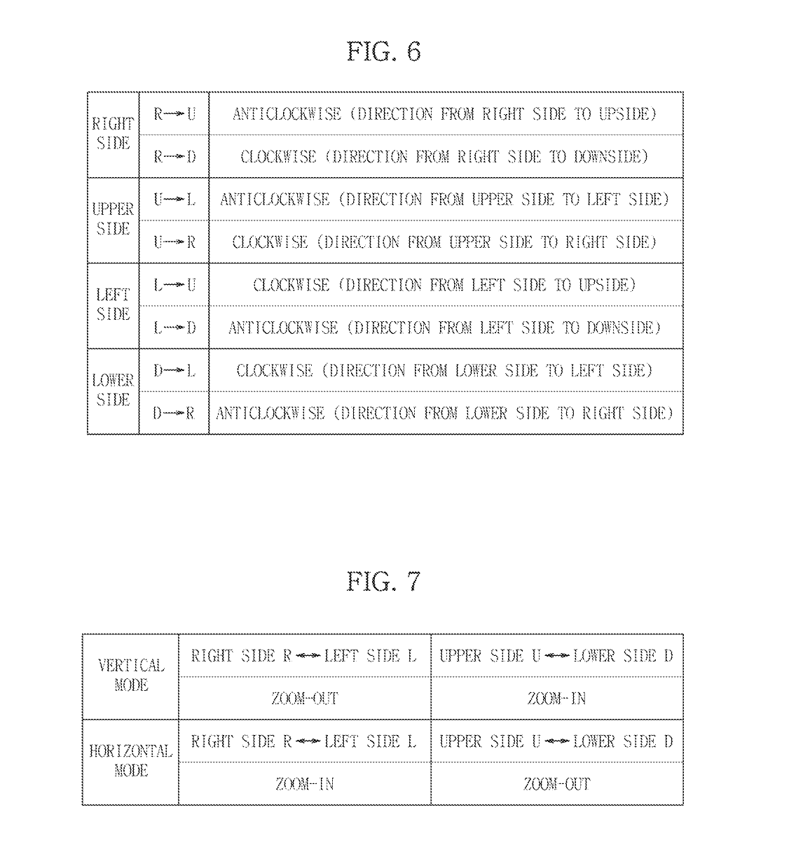

FIG. 7 shows a table exemplarily illustrating the scaling operation of the image displayed on the screen by an embodiment of the present disclosure.

As to the scaling operation of the image, there are two operations, enlargement and reduction (i.e. zoom-in and zoom-out).

In this embodiment, the work type selecting unit 120 selects the scaling of the image as the work type, when the touch type is a dual and simultaneous touch of a pair of command spots facing each other, located at the center on the each side (for example, L on the left side and R on the right side). Whether zoom-in or zoom-out of the image is determined on the basis of the touch position, and the scaling (zoom-in and zoom-out) ratio is determined by the touch time. Thus the work type selecting unit 120 directs the unit 130 to perform zoom-in and zoom-out of the image by the set ratio.

The zoom-in or zoom-out of the image could be executed when the user simultaneously touches a pair of command spots facing each other on the command area. Then, there can be two pair of command spots which can be selected by a user, namely a pair of the left and right command spots and a pair of the upper and lower command spots. The distance between some pair of command spots could be longer than the distance of the other pair due to the rectangle shape of the screen. In this case, the work type selecting unit 120 performs zoom-in of the image when the distance between the two touched command spots is longer, and performs zoom-out when the distance between the two touched command spots is shorter.

In the vertical (portrait) mode in which the vertical length of the screen is longer than the horizontal one, the zoom-in of the image is performed when the upper and lower command spots facing each other are touched simultaneously, and the zoom-out is performed when the left and right command spots facing each other are touched simultaneously. For example, in FIG. 2A, the zoom-out (reduction) of the image is performed when the user simultaneously touches ‘R’ on the right side and ‘L’ on the left side, and the zoom-in (enlargement) of the image is performed when the user touches ‘U’ on the top and ‘D’ on the bottom simultaneously.

In the horizontal (landscape) mode in which the horizontal length of the screen is longer than the vertical length, the zoom-in of the image is performed when the left and right command spots facing each other are touched, and the zoom-out of the image is performed when the up and down command spots facing each other are touched. For example, in FIG. 2B, the zoom-in of the image is performed when the user simultaneously touches (presses) ‘R’ on the right side and ‘L’ on the left side, and the zoom-out of the image is performed when the user touches (presses) ‘U’ of the upside and ‘D’ of the downside.

In summary these rules are shown in the table of FIG. 7. In FIG. 7, the two-way arrow (←→) represents the simultaneous contact.

Referring to FIG. 7, the zoom-in of the image is performed when the distance between the two touched command spots is longer, and the zoom-out of the image is performed when the distance between the two touched command spots is shorter. Accordingly the user could easily memorize the operation manner and rapidly learn it.

In this embodiment, the work type selecting unit 120 could set the scaling (zoom-in and zoom-out) ratio on the basis of the touch time. For example, the work type selecting unit 120 could compare the touch time with the preset time (for example the interval between 0.3 and 0.5 second), and perform zoom-in of the image larger than once and less than twice as much (for example, 1.2 to 1.5) when the touch time is shorter than the preset time, and could perform zoom-in of the image twice or more as much when the touch time is longer than the preset time. The zoom-out ratio could be set as the reciprocal of the zoom-in ratio.

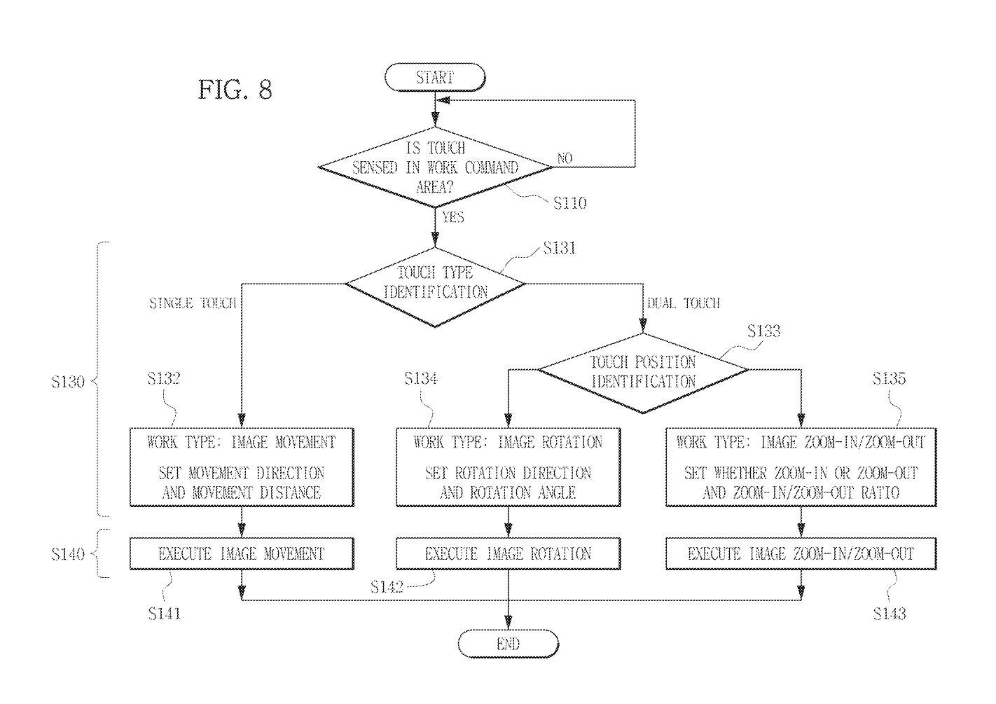

FIG. 8 is the flowchart illustrating the screen control method of the display apparatus having touch screen by the embodiment of the present disclosure.

S110 is the touch sensing process.

Firstly, the work command area including the plural command spots along each side of the touch screen is displayed on the display apparatus. In this case, as the user touches the work command area, the touch input sensing unit 110 senses a touch type, a touch position, and a touch time (S110).

S120 is the work type selecting process.

The work type selecting unit 120 selects the work type to do such as scrolling, rotation, and scaling of the image on the basis of touch type, touch position, and touch time sensed in S110.

In this embodiment, the work type selecting unit 120 identifies the touch type (S131), and when the touch type is a single touch, the scroll of the image is selected as the work type (S132). When the touch type is a dual touch as identified by S131 and the touch position (S133), the rotation and the scaling of the image is selected as the work type (S134, S135).

When the touch type is a single touch as identified by S131, the work type selecting unit 120 proceeds to S132, selects the scroll of the image as the work type, and sets the scroll direction and distance of the image on the basis of the touch position and the touch time.

When the touch type is found to be a dual touch from the identification by S131 and the dual touch spots are found to be the two command spots (including the middle command spot) in any one side of the command area (for example, R and U of the right side) as identified by S133, then the work type selecting unit 120 proceeds to S134 and selects the rotation of the image as the work type. Then the work type selecting unit 120 sets the rotation direction and angle on the basis of the touch position and time of two touched spots. The rotation angle could be set by the touch time and the touch type, and the touch could be either simultaneous or sequential.

When the touch type is found to be a dual touch from the identification by S131, and the dual touch spots are found to be a pair of command spots (for example, L on the left side and R on the right side) facing each other, identified by S133, then the work type selecting unit 120 proceeds to S135 and selects the scaling of the image as the work type. Thus, the work type selecting unit 120 determines whether the work to be done is zoom-in or zoom-out of the image as well as the scaling (zoom-in and the zoom-out) ratio on the basis of the touch position and the touch time.

S140 is a work executing process.

The work executing unit 130 executes any one operation among the scrolling, rotation, and scaling of the image on the basis of the work type selected through S130.

When the scrolling of the image is selected as the work type, the work executing unit 130 scrolls the image to the scrolling direction by the scrolling distance set in S132 (S141). When the rotation of the image is selected as the work type, the work executing unit 130 rotates the image to the rotation direction by the rotation angle set in S134 (S142). When the scaling of the image is selected as the work type, the work executing unit 130 performs zoom-in or zoom-out of the image by zoom-in or zoom-out ratio set in S135 (S143).

The embodiments of the present disclosure have perfect rotational symmetry. Accordingly, in the horizontal mode (landscape) or the vertical mode (portrait), or even when the image is rotated by 180°, the role of each spot is not changed and is kept as it is. In addition, as compared with the conventional technique which needs dragging, more concentration by the user would be necessary, but it is expected that there is some effect of preventing excessive immersion of the user to mobile device. This is because the immersion frequently occurs in a relatively relaxed state.

The display apparatus having touch screen and the screen control method thereof by the present disclosure is not limited to the embodiments described above, and could be variously modified in the scope permeated in the technical sprit of the present disclosure.

What is claimed is:

1. A display apparatus having a touch screen comprising:
a touch input sensing unit that senses a touch type, a touch position, and a touch time by the user touch input in a work command area having the shape of a band along each side of the touch screen;
a work type selecting unit that selects scrolling of an image displayed on the touch screen as a work type when the touch type is a single touch, and selects rotation of the image or scaling of the image by the touch position when the touch type is a dual touch, based on the touch type, the touch position, and the touch time sensed from the touch input sensing unit; and
a work executing unit that executes any one work of the scrolling, rotation, and scaling of the image based on the work type selected from the work type selecting unit.

2. The display apparatus having a touch screen according to claim 1,
wherein each side of the work command area has plural command areas including a middle spot, two separated neighbor spots near the middle spot, and two additional consecutive or separated spots on the edge of the each side.

3. The display apparatus having a touch screen according to claim 2,
wherein five divisional spots, two of which are located at the corner or near the corner on each side on the screen that appear when a user touches the work command area.

4. The display apparatus having a touch screen according to claim 2,
wherein the work type selecting unit sets a scrolling direction and a scrolling distance of an image based on the touch position and the touch time when the touch type is a single touch, and
wherein the work executing unit scrolls the image based on the set scrolling direction and the set scrolling distance.

5. The display apparatus having a touch screen according to claim 4,
wherein when the scrolling direction of the image is set by the command area touched by the user, the work executing unit scrolls the image by x/n in the set scrolling direction when the touch time is shorter than a preset time, and scrolls a whole of the image in the set scrolling direction when the touch time is longer than the preset time,
where n is a natural number, x is a vertical length of the touch screen when the set scrolling direction is vertical, x is a horizontal length of the touch screen when the set scrolling direction is horizontal, and x is a diagonal length of the touch screen when the set scrolling direction is diagonal.

6. The display apparatus having a touch screen according to claim 2,
wherein the work type selecting unit sets a rotation direction and a rotation angle of the image based on the touch position and the touch time when two command area on one side of the work command area, including the middle spot of the side, are dual-touched, and
wherein the work executing unit rotates the image based on the set rotation direction and rotation angle.

7. The display apparatus having a touch screen according to claim 6,
wherein the work type selecting unit sets the rotation direction to either clockwise or anticlockwise based on a direction from the touched center spot to the touched other consecutive command area,
wherein when the two command areas are dual-touched simultaneously, the work type selecting unit sets the rotation angle in an acute angle in proportion to the touch time, and
wherein when the two command areas are dual-touched sequentially, the work type selecting unit sets the rotation angle to 90°.

8. The display apparatus having a touch screen according to claim 6,
wherein a rotation center is set to the center of the touch screen, the midpoint of a side facing the side touched by the user, or the points on the corner of the touch screen, and
wherein when the corner point is chosen to be the rotation center, the furthermost corner point from the two touched command areas would be selected

9. The display apparatus having a touch screen according to claim 2,
wherein when a pair of command areas facing each other on the touch screen are simultaneously dual-touched, the work type selecting unit sets whether the image is enlarged or reduced and an enlargement ratio or a reduction ratio of the image based on the touch position and the touch time, and
wherein the work executing unit enlarges or reduces the image by the set enlargement ratio or the set reduction ratio.

10. The display apparatus having a touch screen according to claim 9,
wherein when the pair of command areas are a pair of left and right command areas facing each other and a pair of upper and lower command areas facing each other, the image is enlarged when the distance between the touched one pair of command areas is longer than that between the untouched other pair, and the image is reduced when the distance between the touched one pair of command areas is shorter than that between the untouched other pair, and
wherein the image is enlarged more than once and less than twice as much when the touch time is shorter than the preset time, the image is enlarged equal to or more than twice as much when the touch time is longer than the preset time, and the reduction ratio is applied as a reciprocal of the enlargement ratio.

11. A screen control method of a display apparatus having a touch screen comprising:
sensing a touch type, a touch position, and a touch time by a user touch input in the work command area, wherein the work command area has a shape of a band along each side of the touch screen and includes plural command areas;
selecting scrolling of an image displayed on the touch screen when the touch type is a single touch, and selecting rotation of the image or scaling of the image by the touch position when the touch type is a dual touch, based on the sensed touch type, touch position, and touch time; and
executing any one work of the scrolling, the rotation, and the scaling of the image based on the selected work type.

12. The screen control method of a display apparatus having a touch screen according to claim 11,
wherein said selecting of the work type includes:
setting a scrolling direction and a scrolling distance of the image based on the touch position and the touch time, wherein the touch position is the spot touched by a single touch;
selecting the rotation of the image as the work type, and setting a rotation direction and a rotation angle of the image based on the position of two spots and the touch time, wherein the two command areas on each side of the work command area are dual-touched and include mandatorily the middle spot of the each side; and
selecting the scaling of the image as the work type, and setting enlargement or reduction as well as an enlargement ratio or a reduction ratio of the image, based on the touch position and the touch time, when the touch position is a pair of command areas facing each other on the touch screen and dual-touched.
